(19) United States
(12) Patent Application Publication
(10) Pub. No.: US 2015/0298762 A1
(43) Pub. Date: Oct. 22, 2015

(54) BICYCLE PEDAL

(71) Applicant: VP COMPONENTS CO., LTD., Taichung City (TW)

(72) Inventor: Wen-Hwa LIN, Taichung City (TW)

(73) Assignee: VP COMPONENTS CO., LTD., Taichung City (TW)

(21) Appl. No.: 14/254,845

(22) Filed: Apr. 16, 2014

(51) Int. Cl. B62M 3/08

(52) U.S. Cl. CPC B62M 3/08

(57) ABSTRACT

A bicycle pedal which is rotatably installed on a bicycle crank includes a main body, a pedal axle, at least a fixing rod, and a bushing unit. Therein, the main body has with an axle bore and at least a through hole extending from the outer periphery of the main body and connected with the axle bore. The pedal axle has a first end combined to the crank and a second end inserted in the axle bore, whereby the main body is allowed to rotate against the pedal axle. The fixing rod is removably disposed in the through hole and interferes with the movement of the pedal axle for preventing the main body from being relatively separated from the pedal axle. The bushing unit is disposed between the main body and the pedal axle.

### BACKGROUND OF THE INVENTION

1. Field of the Invention

The present invention relates to pedals, and more particularly, to a bicycle pedal.

2. Description of the Related Art

Bicycle pedals are applied for being pedaled by users in order to trigger the rotation of bicycle cranks, whereby the bicycle chain and wheels revolve and drive the bicycle to move. However, after being used for a period of time, when the pedals loosen or the components are damaged, the pedals need to be renewed or adjusted.

As shown by the patent TW M462224, a known pedal axle assembly comprises an axle 1 having a connecting end 11 for being screwed to the bicycle crank and a fixing end 12 screwed by a screw member 3, whereby the axle 1 is rotatably disposed in a pedal 4. Components of such structure are numerous and complex, while the axle 1 needs to be inserted through the pedal 4 for being screwed by the screw member 3. As a result, the length of the pedal 1 is not adjustable, and the pedal 1 occupies certain space of the pedal 4, causing the overall weight of the pedal 4 to remain heavy, failing to meet the requirement of being a light-weight product.

Also, as shown by the patent TW M455673, a pedal bearing comprises an axle 2 inserted in an axle bore 11 of a main body 1 of a bicycle pedal, wherein the axle 2 and a cover 4 are fixed in a manner of riveting. However, the fixing manner of the axle 2 and the cover 4 has to be broken when the structure needs to be disassembled. As a result, the end part of the axle 2 tends to be roughened, causing the uneasiness of the axle 2 detaching from the main body 1.

Therefore, an improvement of bicycle pedals is needed to overcome known disadvantages for meeting users demand.

### SUMMARY OF THE INVENTION

For improving the issues aforementioned, the present invention discloses a bicycle pedal, wherein the pedal axle is allowed to be detached easily from the main body, thereby facilitating the renewal of pedals.

For achieving the objectives, the present invention provides a bicycle pedal, which is rotatably installed on a bicycle crank, comprising:

a main body, provided with an axle bore and at least a through hole, while the through hole extends from the outer periphery of the main body and is connected with the axle bore;

a pedal axle, provided with a first end combined to the crank and a second end inserted in the axle bore, whereby the main body is allowed to rotate against the pedal axle;

at least a fixing rod, removably disposed in the through hole and interfering with the movement of the pedal axle for preventing the main body from being relatively separated from the pedal axle; and

a bushing unit, disposed between the main body and the pedal axle.

Therefore, when the bicycle pedal is used for a period of time and pedal becomes loosened or components were damaged, the user is able to detach the fixing rod from the through hole, whereby the pedal axle is easy to be removed from the main body, and the renewal or maintenance of components is facilitated.

### BRIEF DESCRIPTION OF THE DRAWINGS

FIG. 1 is a perspective view of the bicycle pedal in accordance with the present invention.

FIG. 2 is an exploded view of the bicycle pedal in accordance with the present invention.

FIG. 3 is a transverse cross-sectional view of the bicycle pedal in accordance with the present invention.

FIG. 4 is a longitudinal cross-sectional view of the bicycle pedal in accordance with the present invention.

FIG. 5 is a schematic view illustrating the status of the pedal axle interfering with the fixing rod.

### DETAILED DESCRIPTION OF THE INVENTION

Other and further advantages and features of the present invention will be understood by reference to the description of the preferred embodiment in conjunction with the accompanying drawings where the components are illustrated based on a proportion for explanation but not subject to the actual component proportion.

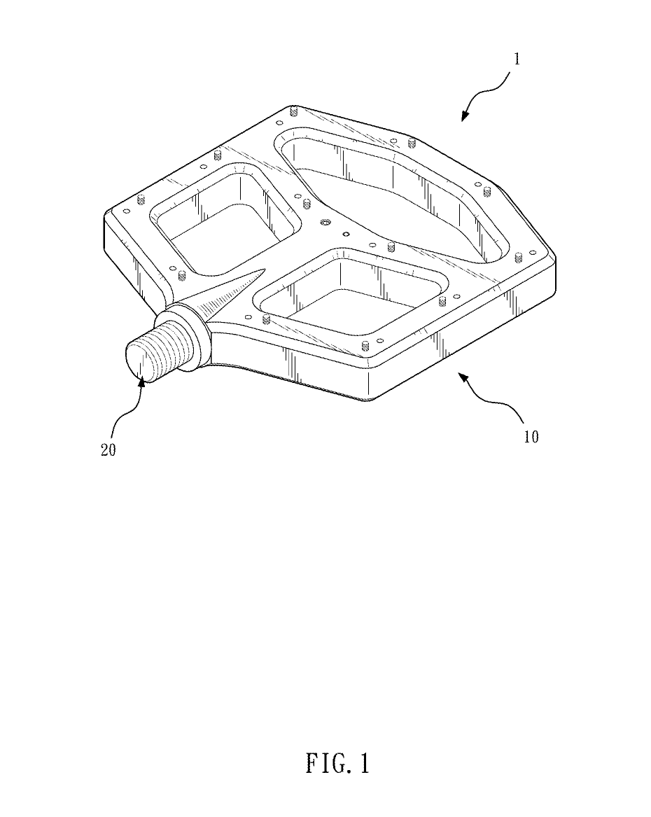

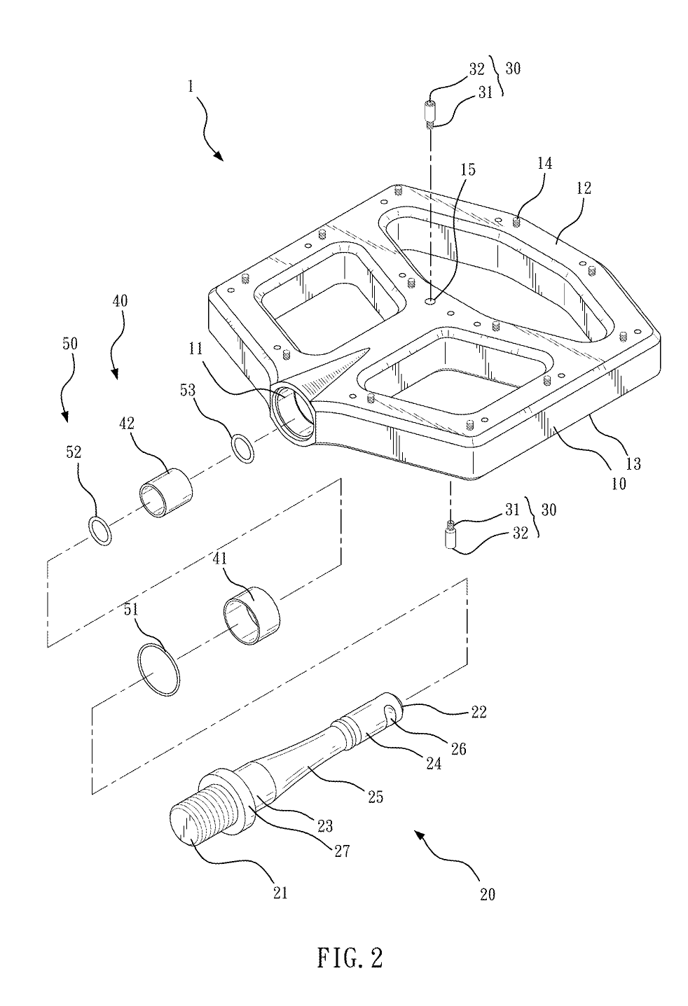

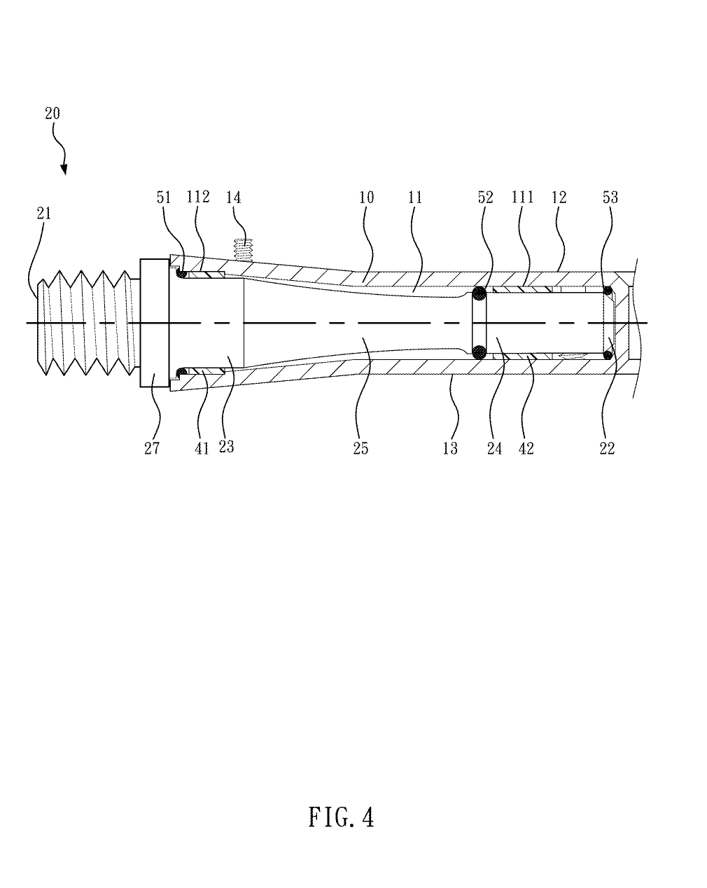

Referring to FIG. 1 to FIG. 5, the bicycle pedal 1 provided by the present invention is rotatably installed on a bicycle crank, comprising a main body 10, a pedal axle 20, at least a fixing rod 30, and a bushing unit 40.

The main body 10 is provided with an axle bore 11 with one end thereof as a sealed end and the other end thereof as an open end. A small diameter section 111 is disposed adjacent to the sealed end, while a large diameter section 112 is disposed adjacent to the open end. Also, a first pedal surface 12 and an opposite second pedal surface 13 are disposed on the main body 10, wherein the first and second pedal surfaces 12, 13 are provided with plural anti-skidding members 14, respectively, for providing an efficient anti-skidding effect during the pedaling process of the user.

At least one through hole 15, extends from the outer periphery of the main body 10 and is connected with the axle bore 11. In the embodiment of the present invention, two through holes 15, present as two screw holes, extend perpendicularly from the first and second pedal surfaces 12, 13, respectively, and are both connected to the axle bore 11, respectively. However, the embodiment is not for limiting the scope of the present invention.

A pedal axle 20 is provided with a first end 21 and a second end 22, with the first end 21 screwed to the crank and the second end 22 inserted in the axle bore 11. The pedal axle 20 further comprises a first straight section 23 and a second straight section 24, with a tapering section 25 disposed between the first and second straight sections 23, 24, wherein the first straight section 23 tapers toward the second straight section 24. When the pedal axle 20 is installed in the axle bore 11, the first straight section 23 is disposed in the large diameter section 112, while the second straight section 24 is disposed in the small diameter section 111. In addition, the second straight section 24 is further provided with a neck 26 and also a ring part 27 adjacent to the second end 22, while the ring part 27 is able to mask the open end of the axle bore 11.

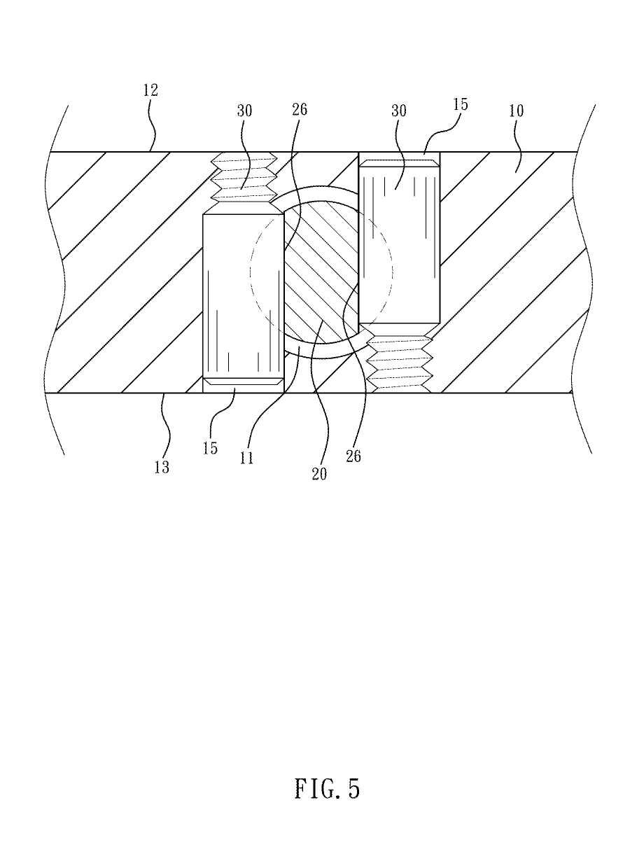

The fixing rod 30, which can be a countersunk screw, is removably disposed in the through hole 15. In the embodiment of the present invention, two fixing rods 30 are provided, with one end thereof comprises a screw part 31, respectively, whereby the fixing rods 30 are screwed to the through hole 15 and capable of being latched with the neck 26 of the pedal axle 20 to interfere with the pedal axle 20 (as shown in FIG. 5) for preventing the main body 10 from being separated from the pedal axle 20. Furthermore, the other end of the fixing rod 30 is provided with a driving part 32 which is a hexagonal hole, thereby being driven by a tool. In addition, when the fixing rod 30 is combined in the through hole 15, the driving part 32 is kept from exposing on the first and second pedal surfaces 12, 13 to prevent the pedaling process from being affected.

The bushing unit 40 is disposed between the main body 10 and the pedal axle 20. The bushing unit 40 comprises a first DU bushing 41 and a second DU bushing 42. Therein, the length of the first DU bushing 41 is shorter than the length of the second DU bushing 42, while the outer diameter of the first DU bushing 41 is larger than the outer diameter of the second DU bushing 42. The first DU bushing 41 sleeves the first straight section 23 of the pedal axle 20 and the second DU bushing 42 sleeves the second straight section 24 of the pedal axle 20. The first and second DU bushing 41, 42 are axially disposed on the pedal axle 20 with an in-between interval, and at the same time disposed between the main body 10 and the pedal axle 20, whereby the main body 10 is allowed to rotate against the pedal axle 20.

A resilient supporting unit 50 sleeves the pedal axle 20 and comprises three rings 51, 52, 53. The ring 51 sleeves the pedal axle 20 and contacts the first DU bushing 41 for being correspondingly installed in the large diameter section 112; the rings 52, 53 sleeve the pedal axle 20 on two sides of the second DU bushing 42 for being correspondingly installed in the small diameter section 111, thereby preventing gaps between the pedal axle 20 and the main body 10 from occurring.

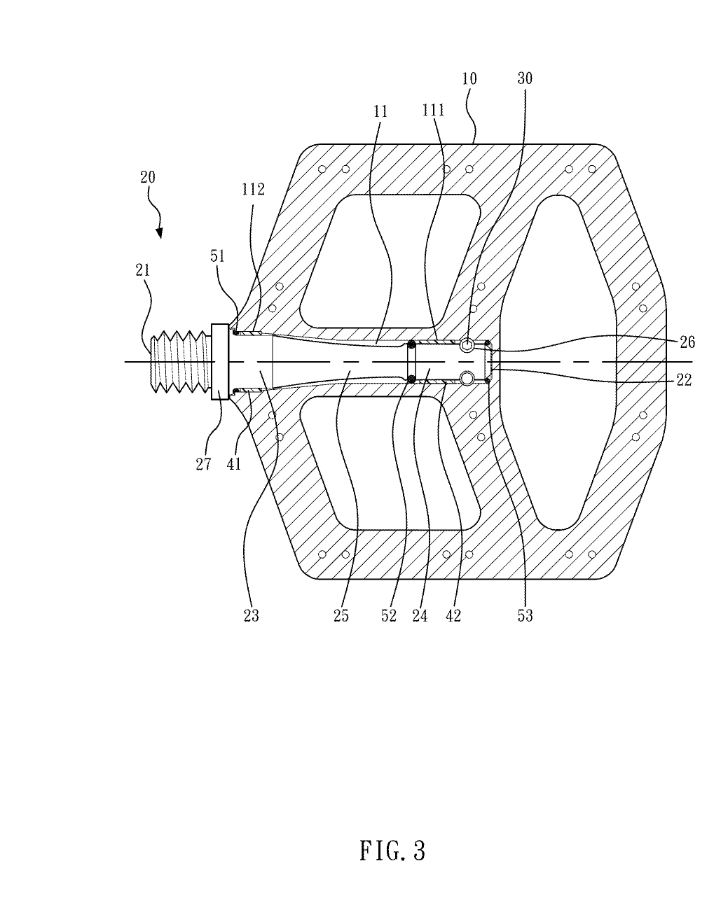

Referring to FIG. 3 and FIG. 5, the pedal axle 20 is inserted in the axle bore 11 of the main body 10, and the neck 26 of the pedal axle 20 is latched by the fixing rods 30 screwed in the through holes 15 of the first and second pedal surfaces 12, 13. In addition, the fixing rods 30 interfere the movement of the pedal axle 20, whereby the pedal axle 20 is fastened in the axle bore 11 of the main body 10 and prevented from being separated from the axle bore 11. Therefore, when the bicycle pedal 1 is loosened or components are damaged due to being used for a period of time, user is allowed to apply a hexagonal wrench for unscrewing the fixing rods 30 from the through holes 15, whereby the pedal axle 20 is allowed to be separated from the main body 10. Thus, easiness of maintenance is achieved, and original components and functions thereof are not going to be broken or malfunctioned during the process of disassembling.

Especially, in the embodiment of the present invention, the pedal axle 20 is interfered and latched by the two fixing rods 30, wherein one of the fixing rods 30 is perpendicularly screwed into the first through holes 15 from the first pedal surface 12, and the other fixing rod 30 is perpendicularly screwed into the second through hole 15 from the second pedal surface 13, whereby the pedal axle 20 is latched by the two fixing rods 30 disposed in opposite directions. The latched effect of the pedal axle 20 is thus reinforced, while the condition of components loosening is efficiently prevented.

Furthermore, the first and second DU bushing 41, 42 of the present invention are axially disposed on the pedal axle 20 with an in-between interval, and at the same time disposed between the main body 10 and the pedal axle 20, whereby the main body 10 is allowed to rotate against the pedal axle 20. No bearings are needed for the present invention; therefore, the overall structure of the bicycle pedal 1 is simple, while the volume and thickness of the main body 10 is allowed to be controlled within a certain range. In other words, the bicycle pedal 1 of the present invention is thinner, achieving a lighter weight of the bicycle pedals 1.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A bicycle pedal, rotatably installed on a bicycle crank, comprising:
a main body, provided with an axle bore and at least a through hole, while the through hole extends from the outer periphery of the main body and is connected with the axle bore;
a pedal axle, provided with a first end combined to the crank and a second end inserted in the axle bore, whereby the main body is allowed to rotate against the pedal axle;
at least a fixing rod, removably disposed in the through hole and interfering with the movement of the pedal axle for preventing the main body from being relatively separated from the pedal axle; and
a bushing unit, disposed between the main body and the pedal axle.

2. The bicycle pedal of claim 1, wherein the through hole is perpendicular to the axle bore.

3. The bicycle pedal of claim 1, wherein one end of the fixing rod is provided with a screw part for being screwed to the through hole.

4. The bicycle pedal of claim 3, wherein the other end of the fixing rod is provided with a driving part for being driven by a tool.

5. The bicycle pedal of claim 4, wherein the driving part is kept from exposing on the outer periphery of the main body.

6. The bicycle pedal of claim 1, wherein the main body is provided with a first pedal surface and an opposite second pedal surface, while two through holes and two fixing rods are provided, while the two fixing rods are combined to the corresponding through holes from the first and second pedal surfaces, respectively.

7. The bicycle pedal of claim 6, wherein the through holes are perpendicular to the axle bore, respectively

8. The bicycle pedal of claim 7, wherein one end of each of the fixing rods is provided with a screw part for being screwed to the corresponding through hole.

9. The bicycle pedal of claim 8, wherein the other end of each of the fixing rods is provided with a driving part for being driven by a tool.

10. The bicycle pedal of claim 9, wherein the driving part is kept from exposing on the first and second pedal surfaces.

11. The bicycle pedal of claim 1, wherein the pedal is provided with a neck for being latched by the fixing rod.

12. The bicycle pedal of claim 1, wherein the bushing unit comprises two DU bushings axially disposed on the pedal axle with an in-between interval and at the same time disposed between the main body and the pedal axle.

13. The bicycle pedal of claim 12, wherein the pedal axle further comprises a first straight section and a second straight section, while the first straight section tapers toward the second straight section, with one of the DU bushing sleeving the first straight section and the other DU bushing sleeving the second straight section.

14. The bicycle pedal of claim 1, further comprising a resilient supporting unit sleeving the pedal axle.

15. The bicycle pedal of claim 14, wherein the resilient supporting unit comprises three rings and the axle bore comprises a small diameter section and a large diameter section, while one of the three rings is correspondingly installed in the large diameter section and the other two rings are correspondingly installed in the small diameter section with an in-between interval.
